(19) United States
(12) Patent Application Publication
(10) Pub. No.: US 2013/0244234 A1
(43) Pub. Date: Sep. 19, 2013

(54) STOOL COLLECTION METHODS FOR ANALYSIS OF DNA IN STOOL

(71) Applicant: GLC BIOTECHNOLOGY, INC., Solon, OH (US)

(72) Inventors: YIDING LIU, TWINSBURG, OH (US); BAOCHUAN GUO, SOLON, OH (US); NAIZHEN WANG, TWINSBURG, OH (US)

(73) Assignee: GLC BIOTECHNOLOGY, INC., SOLON, OH (US)

(21) Appl. No.: 13/745,947

(22) Filed: Jan. 21, 2013

Related U.S. Application Data
(60) Provisional application No. 61/589,847, filed on Jan. 23, 2012.

(51) Int. Cl. G01N 1/40

(52) U.S. Cl. CPC G01N 1/40
USPC 435/6.11

(57) ABSTRACT

Methods of stool sample collection for improving DNA extraction and analysis from stool samples. More specifically, collecting stool samples from the same patient on two or more days (consecutively or randomly) and combining those stool samples for improved DNA extraction and analysis.

### CROSS-REFERENCE TO RELATED APPLICATION

The present application claims priority to and the benefit of U.S. provisional patent application number U.S. 61/589,847 filed Jan. 23, 2012, the entire disclosure of which is incorporated herein by reference.

### TECHNICAL FIELD

The invention provides stool collection methods for analysis of deoxyribonucleic acid (“DNA”) in stool.

### BACKGROUND OF THE INVENTION

Colorectal cancer (CRC) is the second deadliest cancer in the US and the early detection is still the best way to eradicate it. It is recommended that all Americans who are 50 years of age or older should undergo CRC screening. Fecal occult blood tests (FOBTs) have been used to screen CRC for many years and continue to be one of the most frequently used screening tools. However, its screening accuracy is marginal. Due to limitations of FOBTs, colonoscopy is used as an alternative for CRC screening, but has the compliance disincentives of unpleasant cathartic preparation, invasive instrumentation, and small risk of harm. In fact, the low patient compliance rate has been a major problem of existing methods. For example, less than 50% of Americans who are 50 years of age of older, have undergone screening within the recommended intervals.

Fecal DNA testing is based on detecting tumor-derived DNA in stool. A typical fecal DNA assay consists of four steps. The first step is to collect stool at a patient home. The second step is to transport the stool to a clinical lab. The third step is to extract DNA from stool. The final step is to detect the markers (DNA analysis) from the stool DNA to identify “CRC positive” patients. Fecal DNA testing is emerging as a promising replacement of FOBTs for CRC screening, as it has all the advantages of FOBTs, but is much more sensitive than FOBTs.

### SUMMARY OF THE INVENTION

However, fecal DNA testing has its own problems impeding its use in clinical applications. One of the problems has been that the amount of human DNA extracted from stool can be low and varies from stool to stool. This is due to the current practice with which, the stool sample of a person was collected just once on one day. This current invention is specifically designed to address this problem.

The present invention provides stool collection methods for the extraction of human DNA (“target DNA”). Specifically, methods of present invention are practiced using multi-day sampling stool technique. This invention is particularly useful for fecal DNA testing, in which human DNA is first extracted from stool, followed by analysis of said human DNA. One of the applications of fecal DNA testing is for colorectal cancer screening.

### DESCRIPTION OF FIGURES

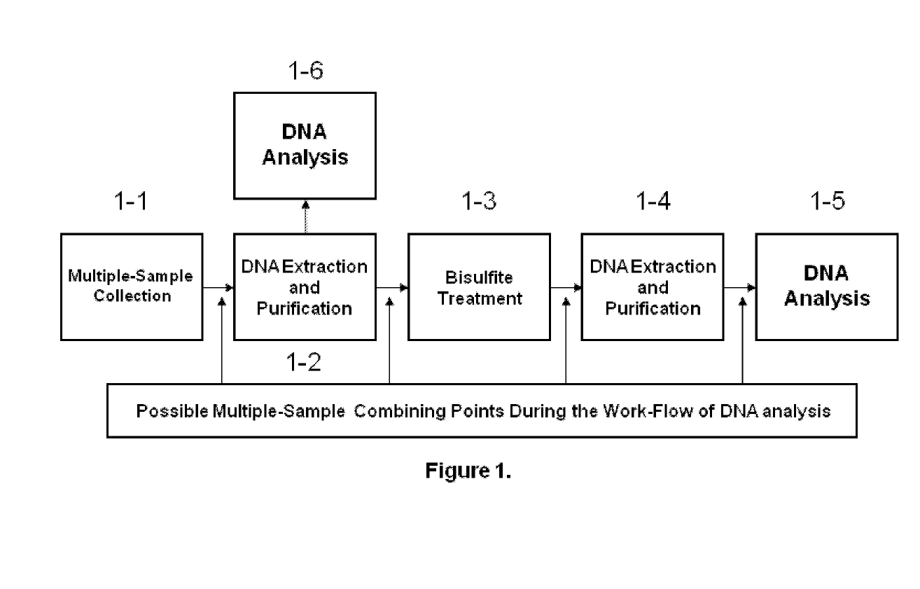

FIG. 1. Schematic representation of multiple-sample collection and combining strategy
1-1 Represent the first stage of the work flow, Stool Sample Collection. It is at this stage where multi-day sampling is performed.
1-2 Represent the second stage of the work flow, DNA Extraction and Purification (before bisulfite conversion). This stage may contain multiple steps of DNA extraction and purification processes. Purified DNA may be subjected to analysis without further processing.
1-3 Represent the third stage of the work flow, Bisulfite Treatment
1-4 Represent the fourth stage of the work flow, DNA Extraction and Purification (after bisulfite conversion). This stage may contain multiple steps of DNA extraction and purification processes.
1-5 Represent the fifth stage of the work flow, DNA Analysis. This stage mainly comprises DNA methylation analysis.
1-6 Represent a DNA Analysis stage before Bisulfite Treatment, include, but not limited to, DNA fragment size analysis and DNA mutation analysis.

Multiple-sample combining can be performed between any of the two stages during the workflow.

### DETAILED DESCRIPTION OF THE INVENTION

The present invention provides a method that reduces the impact of variations of the stool samples on the amount of human DNA extracted from said stool samples. Such methods are especially useful when the amount of human DNA present in some stool samples are low and varies greatly due to biological and environmental changes in colon.

Prior to the present invention, those skilled in the art have not been concerned with the fact that the amount of human DNA in the stool samples could fluctuate greatly in a day-to-day manner.

One of the applications of stool DNA analysis or fecal DNA testing is for colorectal cancer screening. Stool is the most complicated biological sample for clinical uses. Human stool DNA analysis is based on the fact that human cells exfoliate daily, and the physical contact between forming stool and the gastrointestinal tract also generates cell exfoliation. The human cells exfoliated into stool can be collected, from which human DNA can be extracted and analyzed. Therefore, any factors that affect food digestion, stool formation and bowl movement would also have a great impact on the human cell content present in a stool sample, which in turn affects the amount of human DNA that can be extracted from stool. The present invention is designed to reduce the impact of variation of stool on the amount of human DNA that can be extracted from the stool of a person.

In a preferred embodiment, methods of the invention can reduce the possibility of extraction of human DNA from a stool sample that happens to contain the least amount of human DNA. In other words, methods of the invention can reduce the impact of variations of stool on the amount of human DNA extracted from the stool of the same person. Generally, human stool contains only small amounts of human DNA. Most of the human DNA originated from exfoliated epithelial cells. Exfoliated cells were sloughed while forming stool passing through colon. Once the exfoliated human cells are sloughed into stool, they mix with stool and pass through colon. As the biological environment changes from one day to another with many factors involved, the amount of human DNA present in stool also fluctuates daily. In another preferred embodiment, multi-day sampling stool from a single person is performed. In other words, the stool samples of the same person are collected multiple times on consecutive or random multiple days, followed by combining the samples together before analysis of human DNA. Sampling stool more than once on consecutive or random multiple days, followed by combining them before analysis of DNA, can reduce the possibility of extraction of human DNA from the sample that happens to contain the least amount of human DNA. In other words, multi-day sampling stool, followed by combining them before analysis of human DNA can reduce the impact of variation of stool from one day to another on the amount of human DNA extracted from the stool of the same person.

### EXAMPLES

The following experiments demonstrated that amounts of human DNA extracted from the stool samples of the same person can vary greatly from one day to another, and that multiple sampling stool on different days and from different spots of the stool, followed by combining said samples can greatly reduce impact of the variation of stool on the amount of human DNA that can be extracted from the stool of a person.

### Example 1

In a first set of experiments, 5 volunteers were recruited. Each of them provided stool samples collected on 2 different days. All samples were immediately picked up after collection and frozen under −80 degree before use. After thawed, 7.5 grams of each mixed sample (physically stirred with a rod) were mixed with a preservation buffer. 0.5 mL of each homogenized sample was subject to pre-extraction treatment. After pre-extraction treatment, 1 mL of treated lysate (equivalent to 100 mg stool) from each sample was used for DNA extraction. Total DNA (including both human and bacterial DNA) was extracted using a magnetic-beads-based automatic DNA extraction and purification system. In general, the treated stool lysate was mixed with a binding buffer and magnetic beads which can bind to DNA in the binding buffer. After DNA was captured by magnetic beads, the beads were washed, followed by eluting DNA from the beads. The DNA was purified and ready to use for further analysis.

TABBLE 1
Quantification of human DNA in stool collected from 5 volunteers on 2
different days

| | | | Day-to-day |
|---|---|---|---|
| Sample | | | Variation |
| ID | day1 (ng/100 mg) | day2 (ng/100 mg) | (Day2/Day1 * 100%) |
| 0 | 20.87 | 3.49 | 16.71 |
| 1 | 19.40 | 9.09 | 46.84 |
| 2 | 5.44 | 20.37 | 374.62 |
| 3 | 5.88 | 60.30 | 1025.51 |
| 4 | 4.84 | 33.53 | 693.31 |

Human DNA extracted from each stool sample was quantified using real-time qPCR by detecting human Beta-actin gene (ACTB). The PCR condition is described as below: Type-it HRM Master Mix (final concentration 1×, Qiagen), primers (final concentration 0.5 μM, the sequences of the forward and reverse primers are: 5′-GGTAGGTTTGTAGCCTTCATCACG (SEQ ID No.: 1) and 5′-CTTGAGAGGTAGAGTGTGGTGTTG (SEQ ID No.: 2)), BSA (final concentration 0.5 μg/mL), and stool DNA were mixed together and the total PCR volume was adjusted to 20 μL with nuclease free water. Real-time qPCR was performed on Light-cycler 480 II real-time cycler (Roche). The qPCR protocol is described as below: 95° C. for 10 min, followed by 50 cycles of 95° C. for 20 seconds, 62° C. for 30 seconds, and 72° C. for 45 seconds, followed by a 72° C. extension for 3 minutes. And then a high-resolution-melting (HRM) melting curve was generated for quality control with the following settings: 95° C. for 1 minute, 60° C. for 1 minute, then a melting curve was obtained from 60° C. to 95° C. with an increment of 0.02° C./second and 25 acquisitions/° C. The final results were analyzed with Light-cycler 480 software from Roche. The results of quantifying the samples are shown in Table 1. As seen from Table 1, the quantity of human DNA extracted from the samples varied greatly from Day 1 to Day 2 for all five volunteers, ranging from 2-10 times, confirming that the amount of human DNA exacted from the stool collected on different days can vary greatly and that collecting stool multiple times on different days and mixing the stool samples together (multi-spots) is a preferred sampling method for stool DNA analysis.

### Example 2

In the second set of experiments, two volunteers were recruited for the study. Each of them was instructed to collect stool 5 times (once a day) in 5 consecutive days. The collected stool was immediately preserved in a preservation buffer and then frozen under −80 degree until use.

After all samples were collected, stool samples were thawed and homogenized before aliquot. 3 mL of stool lysate was taken from each stool sample for pre-extraction treatments. 7 mL of treated supernatant was collected after pre-extraction treatments. Then, total DNA (including both human and bacterial DNA) was extracted from 1 mL of pre-treated supernatant (equivalent to 100 mg of stool) using a magnetic-beads-based automatic DNA extraction and purification system. In general, the treated stool lysate was mixed with a binding buffer and magnetic beads which can bind to DNA in the binding buffer. After DNA was collected by the magnetic beads, the beads were washed, followed by eluting DNA from the beads. The DNA was purified and ready to use for further analysis.

Human DNA extracted from each stool sample was quantified using real-time qPCR by detecting human Beta-actin gene (ACTB). The PCR condition is described as below: Type-it HRM Master Mix (final concentration lx, Qiagen), primers (final concentration 0.5 μM, the sequences of the forward and reverse primers are: 5′-GGTAGGTTTGTAGCCTTCATCACG (SEQ ID No.: 1) and 5′-CTTGAGAGGTAGAGTGTGGTGTTG (SEQ ID No.: 2)), BSA (final concentration 0.5 μg/μL), and stool DNA were mixed together and the total PCR volume was adjusted to 20 μL with nuclease free water. Real-time qPCR was performed on Light-cycler 480 II real-time cycler (Roche). The qPCR protocol is described as below: 95° C. for 10 min, followed by 50 cycles of 95° C. for 20 seconds, 62° C. for 30 seconds, and 72° C. for 45 seconds, followed by a 72° C. extension for 3 minutes. And then a high-resolution-melting (HRM) melting curve was generated for quality control with the following settings: 95° C. for 1 minute, 60° C. for 1 minute, then a melting curve was obtained from 60° C. to 95° C. with an increment of 0.02° C./second and 25 acquisitions/° C. The final results were analyzed with Light-cycler 480 software from Roche.

The results are shown in Table 2. The amount of human DNA is represented in nano-gram (ng) of human DNA per 100 mg stool. As shown in Table 2, the amount of human DNA extracted from 2 sets of volunteers' samples shown great day-to-day variations. The largest variation is 15.88 times (compared the stools collected from Day1 and Day5) for volunteer 1, and 13.86 times for volunteer 2 (compared the stools collected from Day3 and Day4).

In a next set of experiments, we mixed the Day 5 and Day 1 stool lysates of Volunteer 1, and the Day 3 and Day 4 stool lysates of Volunteer 2 (all in 1:1 ratio) after pre-extraction treatment, followed by extraction of human DNA from the combining stool mixtures before DNA quantification. This study was performed to determine whether combining stool samples collected on different days could reduce the possibility of extraction of human DNA from the stool sample that happens to contain the least amount of human DNA.

The DNA extraction and quantification methods used were the same as those described above. The DNA quantification results were also shown in Table 2. The quantity of DNA detected increased from 12.87 ng/100 mg (Volunteer 1 Day5) to 145.00 ng/100 mg stool (Mixed), and from 7.74 ng/100 mg (Volunteer 2 Day4) to 54.50 ng/100 mg stool (Mixed), respectively.

TABLE 2
Quantification of human DNA in stool collected from two volunteers on 5
consecutive days

| | ng DNA/100 mg | | ng DNA/100 mg |
|---|---|---|---|
| Volunteer 1 | stool | Volunteer 2 | stool |
| Day1 | 204.33 | Day1 | 9.02 |
| Day2 | 17.30 | Day2 | 13.40 |
| Day3 | 49.70 | Day3 | 107.53 |
| Day4 | 25.30 | Day4 | 7.76 |
| Day5 | 12.87 | Day5 | 42.73 |
| Combine the | 145.00 | Combine the | 54.50 |
| Day1 and Day5 | | Day3 and Day4 | |
| stool | | stool | |

The amount of human DNA extracted from stool is critically important to analysis of DNA in stool. If only the stool sample that happens to contain the least amount of DNA in stool (for example, Volunteer 1 Day 5 or Volunteer 2 Day 4) is used to extract human DNA, the amount of human DNA that can be extracted would be small. As a result, fecal DNA testing may fail to detect cancer because of the low quantity of human DNA available for DNA analysis. In contrast, as shown in the second set of experiment, if we collected stool samples on different days, followed by combining them together before DNA analysis, we were able to reduce the possibility of using a stool sample that contained the less amounts of human DNA to extract human DNA.

### CONCLUSION

Daily variation of stool can lead to a great variation on the amount of human DNA extracted from stool. The above experiments show that multi-day stool sampling, followed by combining the stools collected on multiple days can reduce the chance of extracting human DNA from a stool sample that happens to contain a very small amount of human DNA. In one embodiment, the preferred method of present invention comprises collecting multiple stool samples on different days (either consecutively or/and randomly) from the same person and combining said stool samples before performing DNA analysis. The skilled of art can determine the best workflow and sample combining points (FIG. 1). The preferred DNA analysis methods include, but not limited to, DNA quantification, DNA fragment size analysis, DNA mutation analysis, and DNA methylation analysis.

### CITATION LIST

### US Patent Literature

U.S. Pat. No. 5,741,650 Lapidus et al., 1998
U.S. Pat. No. 5,952,178 Lapidus et al., 1999
U.S. Pat. No. 6,268,136 B 1 Shuber et al., 2001
U.S. Pat. No. 6,303,304 B 1 Shuber et al., 2001
U.S. Pat. No. 6,406,857 B 1 Shuber et al., 2002

### Foreign Patent Literature

EP0817968 B 1 Lapidus et al., 2003

What is claimed is:

1. A stool collection method for analysis of human DNA in stool, the method comprising:
(a) Collecting multiple stool samples from a person one or more times on consecutive days or random multiple days; and
(b) Combining said multiple stool samples before human DNA analysis; and
(c) Performing DNA analysis of said human DNA.

2. The method of claim 1 further comprises one or more DNA extraction and purification steps.

3. The method of claim 1 wherein said human DNA analysis further comprises one or more DNA analysis methods.

4. The method of claim 3, wherein said one or more human DNA analysis methods is selected from the group consisting of quantification of DNA, measurement of the DNA fragment size, and DNA mutation analysis.

5. The method of claim 3, wherein said one or more human DNA analysis methods is DNA methylation analysis.

6. The method of claim 5 further comprising a bisulfate treatment step before said DNA methylation analysis.


SEQUENCE LISTING (2 sequences)

SEQ ID NO: 1 - DNA, 24 bp, Homo sapiens
ggtaggtttgtagccttcatcacg

SEQ ID NO: 2 - DNA, 24 bp, Homo sapiens
cttgagaggtagagtgtggtgttg